(19) United States
(12) Patent Application Publication
(10) Pub. No.: US 2016/0282513 A1
(43) Pub. Date: Sep. 29, 2016

(54) Improving Well Survey Performance

(71) Applicant: HALLIBURTON ENERGY SERVICES, INC., Houston, TX (US)

(72) Inventors: Anne Holmes, Gloucestershire (GB); James Mitchell Bowe, Aberdeenshire (GB)

(73) Assignee: Halliburton Energy Services, Inc., Houston, TX (US)

(21) Appl. No.: 14/442,872

(22) PCT Filed: Jul. 31, 2014
(86) PCT No.: PCT/US14/49245

§ 371 Date: May 14, 2015

Related U.S. Application Data
(60) Provisional application No. 62/000,676, filed on May 20, 2014.

(51) Int. Cl. G01V 99/00; E21B 41/00

(52) U.S. Cl. CPC G01V 99/005; E21B 41/0092; E21B 3/00

(57) ABSTRACT

In some aspects, techniques and systems for improving a well survey are described. An error analysis is performed to identify errors associated with operating a well survey instrument in a magnetic environment at a wellbore location. Based on the error analysis, an instrument performance model (IPM) is selected for a well survey by the well survey instrument. In some cases, the IPM is selected such that the errors satisfy specifications of the IPM.

### CROSS-REFERENCE TO RELATED APPLICATIONS

This application claims priority to U.S. Provisional Application Ser. No. 62/000,676, filed on May 20, 2014, entitled “Well Survey Performance,” the entire contents of which is hereby incorporated by reference.

### BACKGROUND

The following description relates to well survey management.

A wellbore can be drilled in a subterranean region according to a well plan, for example, to extract hydrocarbon from the subterranean region. When drilling commences based on the well plan, the well can be periodically surveyed to obtain information describing the well being drilled, and the obtained information can be interpreted, e.g., to compare a planned position and a determined position of the well.

In some instances, multi-station analysis (MSA) software can be used to collect survey measurement data and calculate survey errors resulting from measurements. In some implementations, MSA software can be used to correct measurement errors of the survey data. For example, measured data output from magnetometers may be corrected to account for bias errors, scaling errors, or other types of errors introduced by various effects (e.g., magnetic mud effect) associated with the geomagnetic field.

### DESCRIPTION OF DRAWINGS

FIG. 1 is a schematic diagram of an example well system.

FIG. 2 is a schematic diagram of an example computing system.

FIG. 3 is a flow chart showing an example technique for improving well survey performance.

Like reference symbols in the various drawings indicate like elements.

### DETAILED DESCRIPTION

Some aspects of what is described here relate to improving well survey performance, for example, by linking errors identified by a well survey management system (e.g., using multi-station analysis (MSA) software or other techniques) with an instrument performance model (IPM) of a well survey instrument. In some implementations, an error analysis can be performed to identify errors associated with operating a well survey instrument in a magnetic environment at a wellbore location. The error analysis can identify, for example, multiple error sources of measured well survey data, errors (e.g., including error limits or ranges) of survey data due to the multiple error sources, reliability of any corrections to the survey data, or any other information. In some implementations, the errors can be determined for a specific well profile and location; and the error limits or quality control (QC) limits can vary as a function of wellbore location and attitude. For example, a sensitivity analysis can be performed to determine the accuracy with which cross-axial shielding and axial magnetic interference can be calculated for a well profile and location. The information identified by the error analysis can be linked to an IPM, for example, to select an appropriate IPM with technical specifications suitable for the identified errors, and to determine whether the selected IPM is correctly assigned. As such, an improved check on survey quality can be achieved.

In general, the example techniques described herein can be applied to any borehole or well system where the survey information about the wellbore's position can be derived from, for example, three mutually orthogonal measurements of the instantaneous gravity and magnetic field vectors, with one of the measuring axes aligned along the principal (or along hole) axis of the wellbore; and an IPM used to calculate the magnitude of positional uncertainty associated with these measurements. In some implementations, the example techniques described herein can be performed during a survey program design stage to determine (e.g., for each hole section) which error sources can reliably be calculated using single axis and multi-station analysis correction techniques. By linking the QC limits to an IPM used in the well planning stage, confidence that the survey lies within a calculated uncertainty region (e.g., ellipse of uncertainty) can be improved. In some implementations, the example techniques can also be used during the survey management stage (e.g., either during the data acquisition phase, with historical data, or a combination thereof) for each bit run as a quality check on the single axis calculated values of axial magnetic interference and the calculated values for cross-axial shielding and axial magnetic interference. In some instances, potential directional problems could be revealed during the planning stage Linking the quality assurance (QA) checks to the IPM would provide a more reliable check on the required survey accuracy for the specific well.

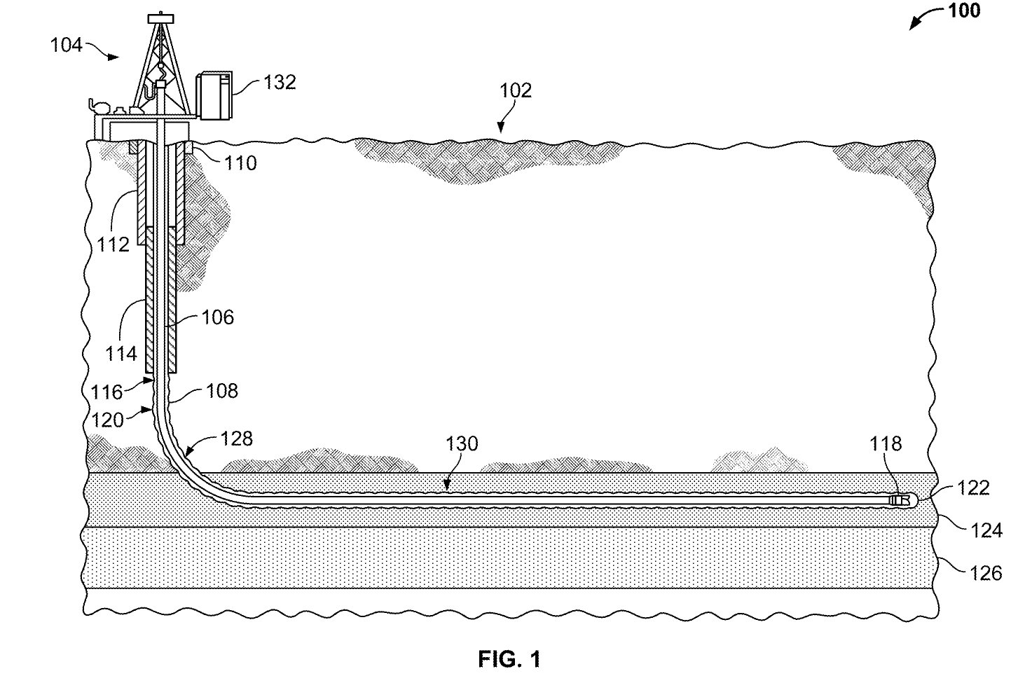

FIG. 1 illustrates an example well system 100. Although shown as a deviated system (e.g., with a directional, horizontal, or radiussed wellbore), the system can include a relatively vertical wellbore (e.g., including normal drilling variations) as well as other types of wellbores (e.g., laterals, pattern wellbores, and otherwise). Moreover, although shown on a terranean surface, the system 100 may be located in a sub-sea or water-based environment. Generally, the deviated well system 100 accesses one or more subterranean formations, and provides easier and more efficient production of hydrocarbons located in such subterranean formations. Further, the deviated well system 100 may allow for easier and more efficient hydraulic fracturing or stimulation operations. As illustrated in FIG. 1, the deviated well system 100 includes a drilling assembly 104 deployed on a terranean surface 102. The drilling assembly 104 may be used to form a vertical wellbore portion 108 extending from the terranean surface 102 and through one or more geological formations in the Earth. One or more subterranean formations, such as productive formation 126, are located under the terranean surface 102. As will be explained in more detail below, one or more wellbore casings, such as a surface casing 112 and intermediate casing 114, may be installed in at least a portion of the vertical wellbore portion 108.

In some implementations, the drilling assembly 104 may be deployed on a body of water rather than the terranean surface 102. For instance, in some implementations, the terranean surface 102 may be an ocean, gulf, sea, or any other body of water under which hydrocarbon-bearing formations may be found. In short, reference to the terranean surface 102 includes both land and water surfaces and contemplates forming and/or developing one or more deviated well systems 100 from either or both locations.

Generally, the drilling assembly 104 may be any appropriate assembly or drilling rig used to form wellbores or wellbores in the Earth. The drilling assembly 104 may use traditional techniques to form such wellbores, such as the vertical wellbore portion 108, or may use nontraditional or novel techniques. In some implementations, the drilling assembly 104 may use rotary drilling equipment to form such wellbores. Rotary drilling equipment is known and may consist of a drill string 106 and a bottom hole assembly (BHA) 118. In some implementations, the drilling assembly 104 may consist of a rotary drilling rig. Rotating equipment on such a rotary drilling rig may consist of components that serve to rotate a drill bit, which in turn forms a wellbore, such as the vertical wellbore portion 108, deeper and deeper into the ground. Rotating equipment consists of a number of components (not all shown here), which contribute to transferring power from a prime mover to the drill bit itself. The prime mover supplies power to a rotary table, or top direct drive system, which in turn supplies rotational power to the drill string 106. The drill string 106 is typically attached to the drill bit within the bottom hole assembly 118. A swivel, which is attached to hoisting equipment, carries much, if not all of, the weight of the drill string 106, but may allow it to rotate freely.

The drill string 106 typically consists of sections of heavy steel pipe, which are threaded so that they can interlock together. Below the drill pipe are one or more drill collars, which are heavier, thicker, and stronger than the drill pipe. The threaded drill collars help to add weight to the drill string 106 above the drill bit to ensure that there is enough downward pressure on the drill bit to allow the bit to drill through the one or more geological formations. The number and nature of the drill collars on any particular rotary rig may be altered depending on the downhole conditions experienced while drilling.

The drill bit is typically located within or attached to the bottom hole assembly 118, which is located at a downhole end of the drill string 106. The drill bit is primarily responsible for making contact with the material (e.g., rock) within the one or more geological formations and drilling through such material. According to the present disclosure, a drill bit type may be chosen depending on the type of geological formation encountered while drilling. For example, different geological formations encountered during drilling may require the use of different drill bits to achieve maximum drilling efficiency. Drill bits may be changed because of such differences in the formations or because the drill bits experience wear. Although such detail is not critical to the present disclosure, there are generally four types of drill bits, each suited for particular conditions. The four most common types of drill bits consist of: delayed or dragged bits, steel to rotary bits, polycrystalline diamond compact bits, and diamond bits. Regardless of the particular drill bits selected, continuous removal of the “cuttings” is essential to rotary drilling.

The circulating system of a rotary drilling operation, such as the drilling assembly 104, may be an additional component of the drilling assembly 104. Generally, the circulating system has a number of main objectives, including cooling and lubricating the drill bit, removing the cuttings from the drill bit and the wellbore, and coating the walls of the wellbore with a mud type cake. The circulating system consists of drilling fluid, which is circulated down through the wellbore throughout the drilling process. Typically, the components of the circulating system include drilling fluid pumps, compressors, related plumbing fixtures, and specialty injectors for the addition of additives to the drilling fluid. In some implementations, such as, for example, during a horizontal or directional drilling process, downhole motors may be used in conjunction with or in the bottom hole assembly 118. Such a downhole motor may be a mud motor with a turbine arrangement, or a progressive cavity arrangement, such as a Moineau motor. These motors receive the drilling fluid through the drill string 106 and rotate to drive the drill bit or change directions in the drilling operation.

In many rotary drilling operations, the drilling fluid is pumped down the drill string 106 and out through ports or jets in the drill bit. The fluid then flows up toward the surface 102 within an annular space (e.g., an annulus) between the wellbore portion 108 and the drill string 106, carrying cuttings in suspension to the surface. The drilling fluid, much like the drill bit, may be chosen depending on the type of geological conditions found under subterranean surface 102. For example, certain geological conditions found and some subterranean formations may require that a liquid, such as water, be used as the drilling fluid. In such situations, in excess of 100,000 gallons of water may be required to complete a drilling operation. If water by itself is not suitable to carry the drill cuttings out of the bore hole or is not of sufficient density to control the pressures in the well, clay additives (bentonite) or polymer-based additives, may be added to the water to form drilling fluid (e.g., drilling mud). As noted above, there may be concerns regarding the use of such additives in underground formations, which may be adjacent to or near subterranean formations holding fresh water.

In some implementations, the drilling assembly 104 and the bottom hole assembly 118 may operate with air or foam as the drilling fluid. For instance, in an air rotary drilling process, compressed air lifts the cuttings generated by the drill bit vertically upward through the annulus to the terranean surface 102. Large compressors may provide air that is then forced down the drill string 106 and eventually escapes through the small ports or jets in the drill bit. Cuttings removed to the terranean surface 102 are then collected.

As noted above, the choice of drilling fluid may depend on the type of geological formations encountered during the drilling operations. Further, this decision may be impacted by the type of drilling, such as vertical drilling, horizontal drilling, or directional drilling. In some cases, for example, certain geological formations may be more amenable to air drilling when drilled vertically as compared to drilled directionally or horizontally.

As illustrated in FIG. 1, the bottom hole assembly 118, including the drill bit, drills or creates the vertical wellbore portion 108, which extends from the terranean surface 102 towards the target subterranean formation 124 and the productive formation 126. In some implementations, the target subterranean formation 124 may be a geological formation amenable to air drilling. In addition, in some implementations, the productive formation 126 may be a geological formation that is less amenable to air drilling processes. As illustrated in FIG. 1, the productive formation 126 is directly adjacent to and under the target formation 124. Alternatively, in some implementations, there may be one or more intermediate subterranean formations (e.g., different rock or mineral formations) between the target subterranean formation 124 and the productive formation 126.

In some implementations of the deviated well system 100, the vertical wellbore portion 108 may be cased with one or more casings. As illustrated, the vertical wellbore portion 108 includes a conductor casing 110, which extends from the terranean surface 102 shortly into the Earth. A portion of the vertical wellbore portion 108 enclosed by the conductor casing 110 may be a large diameter wellbore. For instance, this portion of the vertical wellbore portion 108 may be a 17½″ wellbore with a 13⅜″ conductor casing 110. Additionally, in some implementations, the vertical wellbore portion 108 may be offset from vertical (e.g., a slant wellbore). Even further, in some implementations, the vertical wellbore portion 108 may be a stepped wellbore, such that a portion is drilled vertically downward and then curved to a substantially horizontal wellbore portion. The substantially horizontal wellbore portion may then be turned downward to a second substantially vertical portion, which is then turned to a second substantially horizontal wellbore portion. Additional substantially vertical and horizontal wellbore portions may be added according to, for example, the type of terranean surface 102, the depth of one or more target subterranean formations, the depth of one or more productive subterranean formations, and/or other criteria.

Downhole of the conductor casing 110 may be the surface casing 112. The surface casing 112 may enclose a slightly smaller wellbore and protect the vertical wellbore portion 108 from intrusion of, for example, freshwater aquifers located near the terranean surface 102. The vertical wellbore portion 108 may than extend vertically downward toward a kickoff point 120, which may be between 500 and 1,000 feet above the target subterranean formation 124. This portion of the vertical wellbore portion 108 may be enclosed by the intermediate casing 114. The diameter of the vertical wellbore portion 108 at any point within its length, as well as the casing size of any of the aforementioned casings, may be an appropriate size depending on the drilling process.

Upon reaching the kickoff point 120, drilling tools such as logging and measurement equipment may be deployed into the wellbore portion 108. At that point, a determination of the exact location of the bottom hole assembly 118 may be made and transmitted to the terranean surface 102. Further, upon reaching the kickoff point 120, the bottom hole assembly 118 may be changed or adjusted such that appropriate directional drilling tools may be inserted into the vertical wellbore portion 108.

As illustrated in FIG. 1, a curved wellbore portion 128 and a horizontal wellbore portion 130 have been formed within one or more geological formations. Typically, the curved wellbore portion 128 may be drilled starting from the downhole end of the vertical wellbore portion 108 and deviated from the vertical wellbore portion 108 toward a predetermined azimuth gaining from between 9 and 18 degrees of angle per 100 feet drilled. Alternatively, different predetermined azimuth may be used to drill the curved wellbore portion 128. In drilling the curved wellbore portion 128, the bottom hole assembly 118 often uses measurement-while-drilling (“MWD”) equipment to more precisely determine the location of the drill bit within the one or more geological formations, such as the target subterranean formation 124. Generally, MWD equipment may be utilized to directionally steer the drill bit as it forms the curved wellbore portion 128, as well as the horizontal wellbore portion 130.

MWD surveys can be carried out by making downhole measurements of the earth's gravitational and magnetic vector. For example, the earth's magnetic field can be generally defined in terms of its components in the coordinate system of the survey tool. In some implementations, the central axis running longitudinally along the tool can be designated the z-axis (or the axial direction). Perpendicular to one another and also to the z-axis are the x- and y-axes (cross-axial directions). As such, survey data can include the three mutually orthogonal measurements of the instantaneous gravity and magnetic field vectors along the x-, y-, and z-axes. In some implementations, a total gravity and magnetic field value can be obtained based on the gravity and magnetic field vectors along the x-, y-, and z-axes, respectively.

Alternatively to or in addition to MWD data being compiled during drilling of the wellbore portions shown in FIG. 1, high-fidelity surveys may be taken during the drilling of the wellbore portions. For example, the surveys may be taken periodically in time (e.g., at particular time durations of drilling, periodically in wellbore length (e.g., at particular distances drilled, such as every 30 feet or otherwise), or as needed or desired (e.g., when there is a concern about the path of the wellbore). Typically, during a survey, a completed measurement of the inclination and azimuth of a location in a well (typically the total depth at the time of measurement) is made in order to know, with reasonable accuracy, that a correct or particular wellbore path is being followed (e.g., according to a wellbore plan). Further, position may be helpful to know in case a relief well must be drilled. Surveys can provide high-fidelity measurements that include, for example, inclination from vertical and the azimuth (or compass heading) of the wellbore if the direction of the path is critical. These high-fidelity measurements may be made at discrete points in the well, and the approximate path of the wellbore computed from the discrete points. The high-fidelity measurements may be made with any suitable high-fidelity sensor (e.g., magnetometers, accelerometers, etc.).

The horizontal wellbore portion 130 may typically extend for hundreds, if not thousands, of feet within the target subterranean formation 124. Although FIG. 1 illustrates the horizontal wellbore portion 130 as exactly perpendicular to the vertical wellbore portion 108, it is understood that directionally drilled wellbores, such as the horizontal wellbore portion 130, have some variation in their paths. Thus, the horizontal wellbore portion 130 may include a “zigzag” path yet remain in the target subterranean formation 124. Typically, the horizontal wellbore portion 130 is drilled to a predetermined end point 122, which, as noted above, may be up to thousands of feet from the kickoff point 120. As noted above, in some implementations, the curved wellbore portion 128 and the horizontal wellbore portion 130 may be formed utilizing an air drilling process that uses air or foam as the drilling fluid.

The well system 100 also includes a computing subsystem 132 that is communicative with the BHA 118. The computing subsystem 132 may be located at the wellsite (e.g., at or near drilling assembly 104) or may be remote from the wellsite. The computing subsystem 132 may also be communicative with other systems, devices, databases, and networks. Generally, the computing subsystem 132 may include a processor based computer or computers (e.g., desktop, laptop, server, mobile device, cell phone, or otherwise) that includes memory (e.g., magnetic, optical, RAM/ROM, removable, remote or local), a network interface (e.g., software/hardware based interface), and one or more input/output peripherals (e.g., display devices, keyboard, mouse, touchscreen, and others).

The computing subsystem 132 may at least partially control, manage, and execute operations associated with the drilling operation of the BHA and/or high-fidelity sensor measurements. In some aspects, the computing subsystem 132 may control and adjust one or more of the illustrated components of well system 100 dynamically, such as, in real-time during drilling operations at the well system 100. The real-time control may be adjusted based on sensor measurement data or based on changing predictions of the wellbore trajectory, even without any sensor measurements.

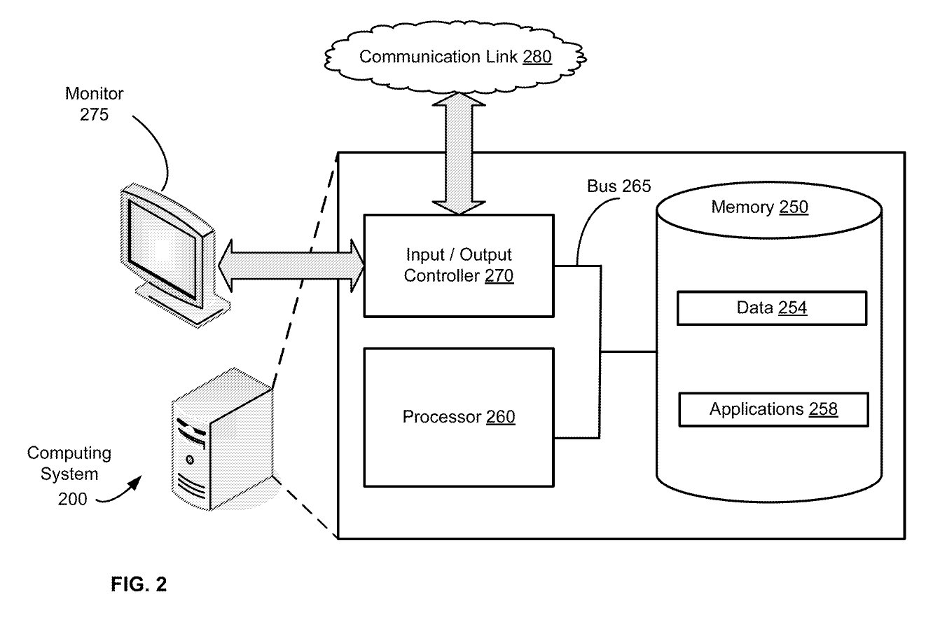

FIG. 2 is a diagram of an example computing system 200. The example computing system 200 can operate as the example computing subsystem 132 shown in FIG. 1, or it may operate in another manner. For example, the computing system 200 can be located at or near one or more wells of a well system or at a remote location apart from a well system. All or part of the computing system 200 may operate independent of a well system or well system components. The example computing system 200 includes a memory 250, a processor 260, and input/output controllers 270 communicably coupled by a bus 265. The memory 250 can include, for example, a random access memory (RAM), a storage device (e.g., a writable read-only memory (ROM) or others), a hard disk, or another type of storage medium. The computing system 200 can be preprogrammed or it can be programmed (and reprogrammed) by loading a program from another source (e.g., from a CD-ROM, from another computer device through a data network, or in another manner). In some examples, the input/output controller 270 is coupled to input/output devices (e.g., a monitor 275, a mouse, a keyboard, or other input/output devices) and to a communication link 280. The input/output devices can receive or transmit data in analog or digital form over communication links such as a serial link, a wireless link (e.g., infrared, radio frequency, or others), a parallel link, or another type of link.

The communication link 280 can include any type of communication channel, connector, data communication network, or other link. For example, the communication link 280 can include a wireless or a wired network, a Local Area Network (LAN), a Wide Area Network (WAN), a private network, a public network (such as the Internet), a WiFi network, a network that includes a satellite link, or another type of data communication network.

The memory 250 can store instructions (e.g., computer code) associated with an operating system, computer applications, and other resources. The memory 250 can also store application data and data objects that can be interpreted by one or more applications or virtual machines running on the computing system 200. As shown in FIG. 2A, the example memory 250 includes data 254 and applications 258. The data 254 can include treatment data, geological data, well survey data, or other types of data. The applications 258 can include well survey management models, drilling simulation software, reservoir simulation software, or other types of applications. In some implementations, a memory of a computing device includes additional or different data, applications, models, or other information.

In some instances, the data 254 can include geological data relating to geological properties of a subterranean region. For example, the geological data may include information on wellbores, completions, or information on other attributes of the subterranean region. In some cases, the geological data includes information on the gravitational field, geomagnetic filed, lithology, fluid content, stress profile (e.g., stress anisotropy, maximum and minimum horizontal stresses), pressure profile, spatial extent, or other attributes of one or more rock formations in the subterranean zone. The geological data can include information collected from well logs, rock samples, outcroppings, microseismic imaging, or other data sources.

In some instances, the data 254 include survey system data. The survey system data can include any data or information that is associated with a well survey system. For example, the survey system data can include well plan data that specifies a well plan and a desired well trajectory, measurement data received during drilling and surveying processes, instrumental performance model (IMP) data that details technical specification of the survey accuracy, or any other types of data. For instance, the survey system data can include the inclination and azimuth of a location in a well, the earth's gravitational and magnetic vector, or any other measurement data that are received from any suitable sensor of the well system or data interpreted and processed by the well survey system.

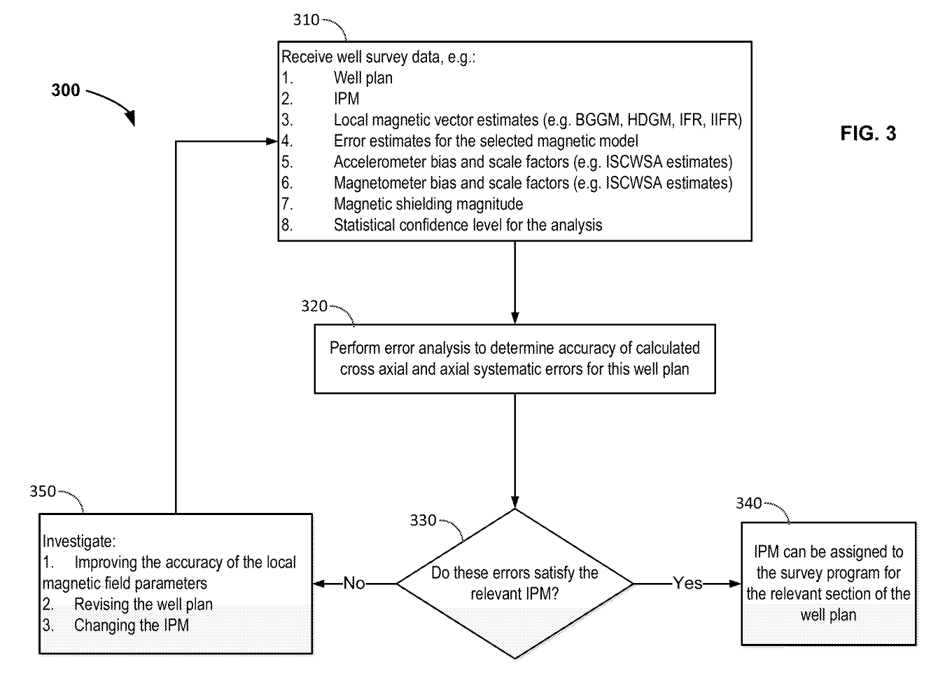

The applications 258 can include software applications, scripts, programs, functions, executables, or other modules that are interpreted or executed by the processor 260. For example, the applications 258 can include a survey management system used to manage a well survey and plan in a well system environment as shown in FIG. 1. The application 258 can include another other type of modules, simulators, and systems. The applications 258 may include machine-readable instructions for performing one or more of the operations related to FIG. 3. The applications 258 may include machine-readable instructions for generating a user interface or a plot, for example, illustrating a well trajectory, or other information. The applications 258 can receive input data such as survey system data, well plan data, IPM data, or other types of input data from the memory 250, from another local source, or from one or more remote sources (e.g., via the communication link 280). The applications 258 can generate output data and store the output data in the memory 250, in another local medium, or in one or more remote devices (e.g., by sending the output data via the communication link 280).

The processor 260 can execute instructions, for example, to generate output data based on data inputs. For example, the processor 260 can run the applications 258 by executing or interpreting the software, scripts, programs, functions, executables, or other modules contained in the applications 258. The processor 260 may perform one or more of the operations related to FIG. 3. The input data received by the processor 260 or the output data generated by the processor 260 can include any of the survey system data (e.g., well plan data, survey management data, IPM), or any other data. For example, the processor 260 can perform a sensitivity analysis to determine if a limit or range of the errors associate with a well survey satisfies the IPM selected for the survey. The processor 260 can manipulate the well survey data (e.g., revise the well plan, change the IPM, etc.) to identify an appropriate IPM for the well plan. In some implementations, the processors 260 can instruct the output device (e.g., a display 275) to present the well trajectory (e.g., to a field engineer, etc.) during a drilling process.

FIG. 3 is a flow chart showing an example process 300 for improving well survey performance. For example, the example process 300 can be used to improve the survey performance of the example well system 100 in FIG. 1. All or part of the example process 300 may be computer-implemented, for example, using the features and attributes of the example computing system 200 shown in FIG. 2 or other computing systems. In some implementations, some or all of the process 300 can be implemented and incorporated into MSA software or program to expand and enhance the capabilities of a well survey management system. The process 300, individual operations of the process 300, or groups of operations may be iterated or performed in parallel, in series, or in another manner. In some cases, the process 300 may include the same, additional, fewer, or different operations performed in the same or a different order.

In some implementations, some or all of the operations in the process 300 are executed during a survey program design or plan stage. In some implementations, some or all of the operations in the process 300 are executed during a survey management stage, for example, in real time during a well survey process where the measurement data are collected, during a drilling process, or during another type of well system activity or phase where historical measurement data have been acquired and stored. An operation can be performed in real time, for example, by performing the operation in response to receiving data (e.g., from a sensor or monitoring system) without substantial delay. Also, an operation can be performed in real time by performing the operation while monitoring for additional data (e.g., from surveying, drilling, or other activities). Some real time operations can receive an input and produce an output during a treatment; in some instances, the output is made available to a user within a time frame that allows the user to respond to the output, for example, by modifying the survey program, the well plan, or another treatment.

At 310, well survey data of a well system can be received or otherwise obtained. The well survey data can include, for example, well plan data, one or more IPMs, and survey management data (e.g., data measured from a well survey instrument, data processed by MSA software, etc.) for a magnetic environment at a wellbore location. In some implementations, the well survey data can include projected or hypothetical data, real-time data, historical data, or a combination thereof. In some implementations, some of the well survey data are time-dependent, location-dependent, or environment-dependent. For example, the well plan data, the IPM, and the measurement data can include data associated with different survey stations, drilling stages, wellbore locations, or subterranean environment. Additional or different data or information can be obtained and used for later processing.

The well plan data can include any data or information describes a well trajectory to be followed to take a well successfully from its surface position to the end of the well trajectory. For example, the well plan can include designed or projected wellbore location, depth, distance, inclination, azimuth, or other information that describe a wellbore position and attitude. Based on factors such as an expected use of a well (e.g., observation, production, injection, or multi-purpose well), parameters (e.g., production parameters, completion requirements, well dimensions, location), an expected life of the well, and conditions of the geological target (e.g., the subterranean reservoir) to be reached by the well, and other factors, the well plan can outline well objectives to be achieved during well drilling and well use.

The IPM (also called a toolcode) can include any information or modules that can be used to simulate a well surveying and planning tool or instrument. For example, an IPM can include a model simulating the performance of the survey tool and the way it was run and processed. In some instances, an IPM can include technical specifications of the survey accuracy, mathematical description of the expected errors, or any other information. For example, an IPM can include mathematical algorithms and constants for determining measurement uncertainty for a well survey instrument under specific downhole conditions. In some implementations, the IPM can specify survey accuracy and provide a confidence indication of whether an actual well trajectory will match the predicted or planned trajectory (e.g., whether the actual wellbore location will hit the target location).

In some implementations, IPM can be specific to a particular survey instrument, a particular survey station, or a specific magnetic or gravitational environment. In some implementations, a survey instrument may have multiple IPMs, for example, depending on the magnetic, gravitational or other subterranean environment to which the survey instrument is applied. Each IPM may describe how the survey instrument performs downhole in the corresponding subterranean environment. In some instances, IPM can be provided by instrument vendor, service company or operating company.

The survey management data can include, for example, local magnetic vector estimates, error estimates for selected magnetic model, accelerometer bias and scale factors, magnetometer bias and scale factors, magnetic shielding magnitude, statistical confidence levels for the analysis, residual errors from the thermal models and rotation check shot data obtained during the tool calibration process, or other information. In some implementations, local magnetic vector estimates can be obtained from the measured-while-drilling (MWD) Geomagnetic Models, for example, British Geological Survey Global Geomagnetic Model (BGGM), High Definition Geomagnetic Model (HDGM), In-Field Referencing (IFR) or Interpolation In-Field Referencing (IIFR) data. The accelerometer bias and scale factors and magnetometer bias and scale factors can be obtained, for example, based on Industry Steering Committee on Wellbore Survey Accuracy (ISCWSA) estimates. In some implementations, survey management data can be obtained from additional or different models and techniques.

At 320, an error analysis can be performed to identify errors associated with operating the well survey instrument in the magnetic environment at the wellbore location. In some implementations, the error analysis can be performed based on the well survey data including, for example, the well plan data and the survey management data. In some implementations, the errors associated with the well survey can be calculated for a particular well location, well attitude, accuracy of the local magnetic field parameters, or another factor. In some instances, the error analysis can include a sensitivity analysis to determine the accuracy of the calculated cross-axial and axial systematic errors for the well plan. As an example, limits of errors in the dip angle and the total magnetic field Bₜₒₜₐₗ can be calculated as a function of well location, well attitude, and accuracy of the local magnetic field parameters. In some instances, the errors in dip and Bₜₒₜₐₗ can be determined based on different error sources including, for example, axial magnetic interference, cross-axial magnetic shielding, errors from magnetometers and accelerometers, or other types of errors. In some implementations, the errors in dip and Bₜₒₜₐₗ can be determined from the following equations, or in another manner.

P=cos γ*sin θ*cos ψ+sin γ*cos θ (1)

Q=cos γ*cos θ−sin γ*sin θ*cos ψ (2)

### Long Collar Azimuth

### Axial Magnetic Interference

$$δ Dip ( δ BZ ) = \frac{Q}{Be} * \frac{180}{π} * δ Bz \qquad ( 3 )$$

δBt(δBz)=P*δBz (4)

### Cross-Axial Magnetic Shielding

$$\begin{matrix}δ Dip ( Sxy ) = - P * Q * \frac{Sxy}{100} * \frac{180}{n} & ( 5 ) \\ δ Bt ( Sxy ) = Be * ( 1 - {P}^{2} ) * \frac{Sxy}{100} & ( 6 )\end{matrix}$$

### Magnetometer Errors

$$δ Dip ( δ {B}_{xyz} ) = \frac{δ {B}_{xyz}}{Be} * \frac{180}{π} \qquad ( 7 )$$

δBt(δB_{xyz})=δB_{xyz} (8)

### Accelerometer Errors

$$δ Dip ( δ {G}_{xyz} ) = δ {G}_{xyz} * \frac{180}{π} \qquad ( 9 )$$

### Short Collar Azimuth

K=1−sin²θ*sin²ψ (10)

### Theoretical Dipe Error

$$\begin{matrix}δ Dipc ( δ Be ) = \frac{P * Q}{K * Be} * δ Be * \frac{180}{π} & ( 11 ) \\ δ Btc ( δ Be ) = ( \frac{{P}^{2}}{K} - 1 ) * δ Be & ( 12 )\end{matrix}$$

### Cross-Axial Shielding

$$\begin{matrix}δ Dipc ( Sxy ) = \frac{- P * Q}{K} * \frac{Sxy}{100} * \frac{180}{π} & ( 13 ) \\ δ Btc ( Sxy ) = ( 1 - \frac{{P}^{2}}{K} ) * Be * \frac{Sxy}{100} & ( 14 )\end{matrix}$$

### Magnetometer Errors

$$\begin{matrix}δ Dipc ( δ {B}_{xyz} ) = \frac{P}{Be * \sqrt{K}} * \frac{180}{π} * δ {B}_{xyz} & ( 15 ) \\ δ Btc ( δ {B}_{xyz} ) = \frac{Q}{\sqrt{K}} * δ {B}_{xyz} & ( 16 )\end{matrix}$$

### Accelerometer Errors

$$\begin{matrix}δ Dipc ( δ {G}_{xyz} ) = \frac{{P}^{2}}{K} * \frac{180}{π} * δ {G}_{xyz} & ( 17 ) \\ δ Btc ( δ {G}_{xyz} ) = \frac{Be * P * Q}{K} * δ {G}_{xyz} & ( 18 )\end{matrix}$$

In the above equations, Be represents local magnetic field strength; γ represents local magnetic dip angle; Bn represents horizontal magnetic field; Θ represents inclination; represents magnetic azimuth; δDip represents calculated dip angle error; δBt represents calculated Bₜₒₜₐₗ error; δDipc represents error in calculated dip angle using short collar correction (SCC, also known as single-stage correction) azimuth; δBtc represents error in calculated Bₜₒₜₐₗ using SCC azimuth; δBz represents axial magnetic interference; S_{xy} represents cross-axial magnetic shielding (%); δB_{xyz} represents magnetometer errors; δG_{xyz} represents accelerometer errors; δDipe represents error in local dip angle; and Beδ represents error in local magnetic field. Additional or different errors of well survey parameters can be determined.

In some instances, the error limit can be determined based on the multiple errors calculated for different error sources, for example, by identifying the maximum error value among the multiple errors. In some instances, the error limit can vary as a function of wellbore location and attitude and can change for each survey station. In some implementations, the error limit can be used as the quality control or quality assurance (QC or QA) metric and can be linked to a specific IPM to provide an improved check on survey quality. In some instances, an appropriated IPM for the well survey by the well survey instrument can be selected based on the error analysis. For example, the IPM can be selected such that the errors identified by the error analysis satisfy specifications of the IPM.

At 330, whether these errors satisfy the IPM can be determined. In some implementations, the determination can be based on a comparison between the error limit and a well survey accuracy specified by the IPM. The accuracy specification of the IPM can include, for example, a range (e.g., associated with a confidence interval), an upper limit, a lower limit, or another type of information indicating the expected accuracy (or uncertainty) of operating the well survey instrument in a subterranean environment. In some instances, if the errors satisfy the IPM (e.g., the error limit falls within an accuracy range specified by the IPM, the maximum error is less than or equal to the upper uncertainty limit specified by the IPM, etc.), the IPM can be assigned to the survey program at 340, for example, for the corresponding section of the well plan.

In some instances, if the errors do not satisfy the IPM (e.g., the maximum error calculated based on the error analysis at 320 exceeds the accuracy specification of the IPM), techniques for manipulating or otherwise processing the well survey data can be performed to select an IPM such that the errors satisfies the IPM at 350. Techniques for processing the well survey data can include, for example, improving the accuracy of the local magnetic field parameters or other survey parameters, revising the well plan, changing the IPM, or other techniques.

In some implementations, the accuracy of the local magnetic field parameters can be improved, for example, by using more accurate and advanced survey instrument or survey management models and techniques. For instance, the local magnetic field parameters can be obtained from IIRF instead of BGGM since typically IIRF provides more accurate local magnetic field parameter values than BGGM. As another example, the errors of magnetometers and accelerometers can be reduced, for example, by using higher-quality magnetometers and accelerometers.

In some implementations, the well plan can be revised, for example, to change the well profile or trajectory. For instance, the well plan can be changed to go through a different gravitational or magnetic environment to avoid interference introduced, for example, by an adjacent well or another source.

In some implementations, the IPM can be changed. For example, another IPM with a less stringent accuracy specification (e.g., with a lower confidence level or interval) can be selected so that the identified error limit fits within the accuracy specification of the new IPM. In some instances, an IPM with a more stringent accuracy specification (e.g., with a higher confidence level or interval) may be selected if the identified upper error limit is much lower than the accuracy specification of the current IPM. In this case, the errors associate with operating the survey instrument can be more tightly fitted into the accuracy specification of the IPM and can the IPM can be more accurate in describing the performance of the survey instrument.

Additional or different techniques can be used. In some implementations, after performing one or more operations at 350, the example process 300 can go back to 310 based on the changed well plan, IPM, or other information. The example process 300 may be performed in an iterative manner until, for example, an appropriate IPM is selected such that the errors associated with the well survey instrument are compatible with the IPM.

Some embodiments of subject matter and operations described in this specification can be implemented in digital electronic circuitry, or in computer software, firmware, or hardware, including the structures disclosed in this specification and their structural equivalents, or in combinations of one or more of them. Some embodiments of subject matter described in this specification can be implemented as one or more computer programs, i.e., as one or more modules of computer program instructions encoded on a computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (Field Programmable Gate Array) or an ASIC (Application Specific Integrated Circuit). The apparatus can also include, in addition to hardware, code that creates an execution environment for the computer program in question; for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code), can be written in any form of programming language, including compiled or interpreted languages, or declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site, or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (Field Programmable Gate Array) or an ASIC (Application Specific Integrated Circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions, and one or more memory devices for storing instructions and data. A computer may also include, or be operatively coupled to receive data from or transfer data to, or both, one or more mass storage devices for storing data, (e.g., magnetic, magneto optical disks, or optical disks). However, a computer need not have such devices. Devices suitable for storing computer program instructions and data include all forms of non-volatile memory, media and memory devices, including, by way of example, semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user, a keyboard and a pointing device (e.g., a mouse, trackball, tablet, touch sensitive screen, or other type of pointing device) by which the user can provide input to the computer. Other kinds of devices can be used to provide for interaction with a user as well; for example, feedback provided to the user can be any form of sensory feedback, (e.g., visual feedback, auditory feedback, or tactile feedback); and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computing system can include one or more computers that operate in proximity to one another or remote from each other, and interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise, for example, by virtue of computer programs running on the respective computers and having a client-server relationship to each other.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of examples have been described. Nevertheless, it will be understood that various modifications can be made. Accordingly, other implementations are within the scope of the following claims.

What is claimed is:

1. A well survey management method comprising:
performing an error analysis to identify errors associated with operating a well survey instrument in a magnetic environment at a wellbore location; and
selecting, based on the error analysis, an instrument performance model (IPM) for a well survey by the well survey instrument.

2. The method of claim 1, wherein selecting the IPM comprises selecting the IPM such that the errors satisfy specifications of the IPM.

3. The method of claim 1, wherein performing the error analysis comprises determining errors based on cross-axial shielding and axial magnetic interference at the wellbore location.

4. The method of claim 1, wherein performing the error analysis comprises determining an error limit of the errors associated with operating the well survey instrument, and selecting an IPM comprises selecting an IPM based on a comparison between the error limit and an accuracy specification of the IPM.

5. The method of claim 4, wherein performing the error analysis comprises determining an error limit of dip angle.

6. The method of claim 4, wherein performing the error analysis comprising determining an error limit of total magnetic field.

7. The method of claim 4, wherein performing the error analysis comprises determining the error limit based on local magnetic field parameters, and the method further comprises, in response to determining that the error limit does not satisfy the accuracy specification of the IPM, improving accuracy of local magnetic field parameters.

8. The method of claim 7, wherein the local magnetic field parameters are obtained from one or more of British Geological Survey Global Geomagnetic Model (BGGM), High Definition Geomagnetic Model (HDGM), In-Field Referencing (IFR) or Interpolation In-Field Referencing (IIFR) data.

9. The method of claim 4, wherein performing the error analysis comprises performing an error analysis associated with a well plan, and the method further comprising, in response to determining that the error limit does not satisfy the accuracy specification of the IPM, revising the well plan.

10. The method of claim 1, wherein the error analysis is performed during a survey program plan stage, and the wellbore location comprises a projected wellbore location of a planned wellbore.

11. The method of claim 1, wherein the error analysis is performed during a well survey management stage, and the wellbore location comprises a location in an existing wellbore.

12. The method of claim 1, further comprising setting quality control limits for a survey station linked to the IPM.

13. A computer system comprising:
data processing apparatus; and
memory storing instructions that, when executed by the data processing apparatus, cause the data processing apparatus to perform operations comprising:
performing an error analysis to identify errors associated with operating a well survey instrument in a magnetic environment at a wellbore location; and
selecting, based on the error analysis, an instrument performance model (IPM) for a well survey by the well survey instrument.

14. The computer system of claim 13, wherein performing the error analysis comprises determining an error limit of the errors associated with operating the well survey instrument, and selecting an IPM comprises selecting an IPM based on a comparison between the error limit and an accuracy specification of the IPM.

15. The computer system of claim 14, wherein performing the error analysis comprises determining the error limit based on local magnetic field parameters, and the operations further comprising, in response to determining that the error limit does not satisfy the accuracy specification of the IPM, improving accuracy of local magnetic field parameters.

16. The computer system of claim 14, wherein performing the error analysis comprises performing an error analysis associated with a well plan, and the operations further comprising, in response to determining that the error limit does not satisfy the accuracy specification of the IPM, revising the well plan.

17. A non-transitory computer-readable medium storing instructions that, when executed by data processing apparatus, cause the data processing apparatus to perform operations comprising:
performing an error analysis to identify errors associated with operating a well survey instrument in a magnetic environment at a wellbore location; and
selecting, based on the error analysis, an instrument performance model (IPM) for a well survey by the well survey instrument.

18. The computer-readable medium of claim 17, wherein performing the error analysis comprises determining an error limit of the errors associated with operating the well survey instrument, and selecting an IPM comprises selecting an IPM based on a comparison between the error limit and an accuracy specification of the IPM.

19. The computer-readable medium of claim 17, wherein the error analysis is performed during a survey program plan stage, and the wellbore location comprises a projected wellbore location of a planned wellbore.

20. The computer-readable medium of claim 17, wherein the error analysis is performed during a well survey management stage, and the wellbore location comprises a location in an existing wellbore.
